(19) United States
(12) Patent Application Publication
(10) Pub. No.: US 2024/0406848 A1
(43) Pub. Date: Dec. 5, 2024

(54) SI Request Handling by Relay UE and Remote UE

(71) Applicant: Telefonaktiebolaget LM Ericsson (publ), Stockholm (SE)

(72) Inventors: Antonino Orsino, Kirkkonummi (FI); Min Wang, Luleå (SE); Nithin Srinivasan, Cologne (DE); Zhang Zhang, Beijing (CN)

(21) Appl. No.: 18/694,264

(22) PCT Filed: Sep. 21, 2022
(86) PCT No.: PCT/EP2022/076237

§ 371 Date: Mar. 21, 2024

(30) Foreign Application Priority Data
Sep. 22, 2021 (WO) PCT/CN2021/119721

(51) Int. Cl. H04W 48/14; H04W 76/27; H04W 88/04

(52) U.S. Cl. CPC H04W 48/14; H04W 76/27; H04W 88/04

(57) ABSTRACT

The present disclosure proposes a method for a relay UE to handle a first SI request received from a remote UE, while a prohibit timer in the relay UE for requesting SI from a base station is running, the method comprising: obtaining SI requested by the first SI request; and sending the SI to the remote UE, once the SI is obtained. With this method, the relay UE is allowed to handle an SI request received from a remote UE effectively, and the remote UE is allowed to get the requested SI via the relay UE as soon as possible.

### TECHNICAL FIELD

The present disclosure relates to a sidelink relay communication in a communication network, particularly to methods and apparatus for a relay User Equipment (UE) to handle a System Information (SI) request received from a remote UE when a prohibit timer in the relay UE is still running. Further, the present disclosure relates to methods and apparatus for a remote UE to handle an SI request to a relay UE.

### BACKGROUND

A feature of cellular systems is their support for direct communication from one User Equipment (UE) to another UE without the transmitted data traversing the base station, which is important for keeping public safety communications connected, especially when there is no network coverage.

Directly-exchanged data and signaling traffic between UEs uses a dedicated set of time and frequency resources known as the “sidelink”, which Third Generation Partnership Project (3GPP) first introduced in Release 12 (Rel-12) of its mobile communication standards. In LTE, Device-to-Device (D2D) communication over the sidelink can take place between UEs that are within a base station's coverage area; if the UEs are being used by public safety personnel, they can also use D2D communications while outside of any base station's coverage area. There are two basic modes of operation for D2D communication via sidelink: in the first one, UEs send signaling messages to the base station that request grants of time and frequency resources that they will use to exchange data, and the base station is responsible for granting those resources so that multiple UEs can use the sidelink to communicate without their transmissions' interfering with each other. This mode only applies to in-coverage cases since the UEs need to communicate with the base station. In the second mode of operations, UEs communicate without grants by using advertised or pre-configured sidelink configuration settings and by selecting time and frequency resources randomly for signaling and data transmissions, possibly introducing UE-to-UE interference due to message collisions. This mode can apply to in-coverage cases but is the only option for out-of-coverage cases.

The original version of Proximity Services (ProSe) defined three basic functions: Discovery, Synchronization, and Communications. There was no provision for the normal Hybrid Automatic Repeat Request (HARQ) feedback, and the communications function was not integrated with the discovery function, nor was it coupled to the synchronization function. 3GPP continued to add features to ProSe in subsequent releases. Release 13 (Rel-13) defined UE-to-Network (U2N) relays, and Release 14 (Rel-14) extended D2D to encompass many more use cases. These enhancements allow full support for in-coverage, out-of-coverage, and partial coverage scenarios enabling first responders to communicate all the time. Rel-14 also adds support for Vehicle-to-Everything (V2X) communications, albeit via modes of communication separate from D2D communication. Among other functions that use broadcast signaling, Rel-14 added the channel sensing and Semi-Persistent Scheduling (SPS) features, which are designed to reduce the probability of collisions when UEs are operating in out-of-coverage mode. Release 15 (Rel-15) added more features, including Carrier Aggregation (CA), transmission diversity, and support for QAM (Quadrature Amplitude Modulation) with a 64-symbol constellation, which allows 6 bits of information to be sent using a single symbol.

The set of releases up to and including Rel-15 are based on the LTE-A interface. The limitations of this interface may prevent future cellular systems from meeting the IMT-2020 performance requirements. Thus, during the past several years, 3GPP has begun work on standards for 5G cellular communications that are based on a new radio interface. These standards include definitions for a new set of radio access technologies collectively known as 5G New Radio (NR). NR operates in two distinct frequency bands: FR1, which is from 410 MHz to 7125 MHz, and FR2, which is a set of millimeter wave bands between 24.250 GHz and 52.600 GHz. NR is enhancing three key capabilities: The first one, called enhanced Mobile BroadBand (eMBB), is designed to provide higher capacity and very high peak data rates, with expected data rates up to 20 Gbit/s in the downlink and 10 Gbit/s in the uplink, and also improved cell edge data rates. This capability aims at supporting applications such as 3D videos and ultra high definition video. The second capability is Ultra-Reliable and Low Latency Communication (URLLC) designed for critical applications such as self-driving (i.e., autonomous) cars, and targets radio access network latency below 1 ms, which is not possible in LTE since the subframe duration is 1 ms. The third capability is massive Machine Type Communication (mMTC) that falls into the smart city concept where there are many sensors providing data, with up to one million devices per square kilometer.

Two UE-based relay capabilities were studied: UE-to-Network (U2N) relay, where a relay UE extends the network connectivity to another remote UE by using direct communication; and UE-to-UE (U2U) relay, where a UE uses two direct communication links to connect two UEs in its proximity that otherwise are not able to communicate.

The U2U relay functionality was not part of the LTE ProSe specification, and its inclusion on NR ProSe can be beneficial for public safety communications range extension for both in-network and off-network use cases. U2N relay functionality is fundamental for network coverage extension for public safety interventions in remote areas, as well as, for wearable devices tethering in commercial use cases (e.g., sensors, virtual reality headsets).

LTE U2N relay functionality uses a Layer 3 (L3) architecture in which the relay of data packets in the PC5 interface (i.e., the sidelink) is performed at the network layer, and UEs connected to a L3 U2N relay are transparent to the network. For NR UE-based relay solutions, two architectures were found feasible: the L3 architecture as in LTE, and a newly defined Layer 2 (L2) architecture in which the relaying in the PC5 interface occurs within the L2, over the RLC (Radio Link Control) sublayer. A remote UE connected to an L2 U2N relay is expected to be seen by the network as a regular UE (i.e., as if it was directly connected to the network), which gives the network control of the connection and services, but requires the definition of several new mechanisms not present or needed in the L3 architecture. These would include, at minimum, a PC5 to Uu adaptation layer for RLC channels and bearer mapping, indirect paging and system information forwarding, and network controlled path switching.

System Information delivery in sidelink relay is specified in section 2.1.3 of TS 38.331. According to section 2.1.3 of TS 38.331, the U2N Remote UE can receive the system information via RRC (Radio Resource Control) signaling, in particular via PC5-RRC message after PC5 connection establishment with U2N Relay UE. The U2N Remote UE in RRC_CONNECTED can use the on-demand System Information Block (SIB) framework to request the SIB(s) via U2N Relay UE. The U2N Remote UE in RRC_IDLE or RRC_INACTIVE can inform U2N Relay UE on its requested SIB type(s) via PC5-RRC message. Then, U2N Relay UE triggers on-demand SI/SIB acquisition procedure as specified in section of 5.2.2.3 of TS38.331 according to its own RRC state (if needed) and sends the acquired SI(s)/SIB(s) to U2N Remote UE via PC5-RRC. For any SIB that the U2N Remote UE requests in on-demand manner, the U2N Relay UE can forward the response. The U2N Relay UE does not decide autonomously which SIB to send to the U2N Remote UE among the ones received from its serving gNB.

### SUMMARY

The current technical specification requires that a UE should have one prohibit timer to present requesting system information too frequently. Every time a UE sends an SI request to the base station, the UE should immediately start the prohibit timer. Before the prohibit timer expires, the UE cannot send another SI request to the base station.

The inventors of the present disclosure find, for system Information delivery in sidelink relay, the above requirement will lead to a problem. For example, if the relay UE has previously sent an on-demand SI request for itself, it needs to wait for the prohibit timer to expire before sending a new SI request, if the new SI request is received from a remote UE before the prohibit timer expires. The current technical specification does not explicitly specify how the relay UE handles an SI request received from a remote UE while the prohibit timer in the relay UE is running. Some relay UE in the prior art, according to its implementation, even will discard the SI request, which is not convenient for applications such as public safety or URLLC where the need to transmit is urgent, especially in case the applications are operated by the remote UE via the relay UE.

One of the objectives of the present disclosure is to resolve or alleviate the above problem.

According to a first aspect of the present disclosure, the objective is achieved by a method for a relay UE to handle a first SI request received from a remote UE, while a prohibit timer in the relay UE for requesting SI from a base station is running, the method comprising: obtaining SI requested by the first SI request; and sending the SI to the remote UE, once the SI is obtained.

According to a second aspect of the present disclosure, the objective is achieved by a relay UE to handle a first SI request received from a remote UE, while a prohibit timer in the relay UE for requesting SI from a base station is running, the relay UE comprising: an obtaining unit, for obtaining SI requested by the first SI request; and a sending unit, for sending the SI to the remote UE, once the SI is obtained.

According to a third aspect of the present disclosure, the objective is achieved by a relay UE to handle a first SI request received from a remote UE, while a prohibit timer in the relay UE for requesting SI from a base station is running, the relay UE comprising: a processor; and a memory, having stored instructions that when executed by the processor cause the relay UE to perform the above method for the relay UE.

The solution of the present disclosure has the following advantages:
allowing a relay UE to handle an SI request received from a remote UE effectively, while a prohibit timer in the relay UE for requesting SI from a base station is running;
allowing the remote UE to get the requested SI via the relay UE as soon as possible.

### BRIEF DESCRIPTION OF THE DRAWINGS

The embodiments herein will now be further described in more detail in the following detailed description by reference to the appended drawings illustrating the embodiments and in which:

FIGS. 1A, 1B, 1C, and 1D schematically illustrates example scenarios for sidelink, in which concepts according to embodiments of the present disclosure may be applied.

FIG. 2 schematically illustrates a flowchart of a method for a relay UE according to the present disclosure.

FIG. 3 is a schematic block diagram of a relay UE of the present disclosure.

FIG. 4 is another schematic block diagram of a relay UE of the present disclosure.

FIG. 5 schematically illustrates a flowchart of a method for a remote UE according to the present disclosure.

FIG. 6 is a schematic block diagram of a remote UE of the present disclosure.

FIG. 7 is another schematic block diagram of a remote UE of the present disclosure.

### DETAILED DESCRIPTION OF EMBODIMENTS

Embodiments herein will be described more fully hereinafter with reference to the accompanying drawings. The embodiments herein may, however, be embodied in many different forms and should not be construed as limiting the scope of the appended claims.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

Also, use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Unless otherwise defined, all terms (including technical and scientific terms) used herein have the same meaning as commonly understood. It will be further understood that terms used herein should be interpreted as having a meaning that is consistent with their meaning in the context of this specification and the relevant art and will not be interpreted in an idealized or overly formal sense unless expressly so defined herein.

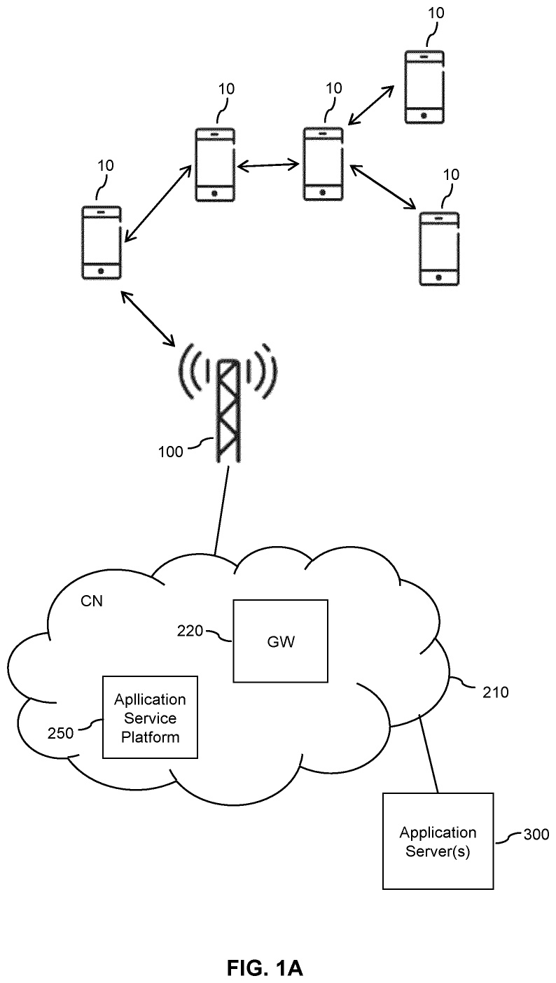

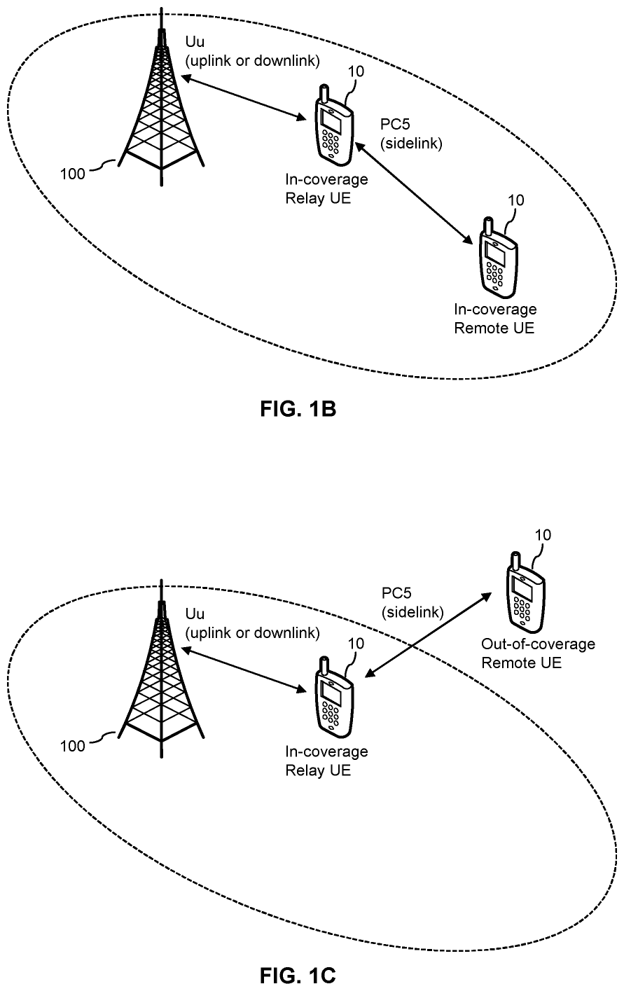

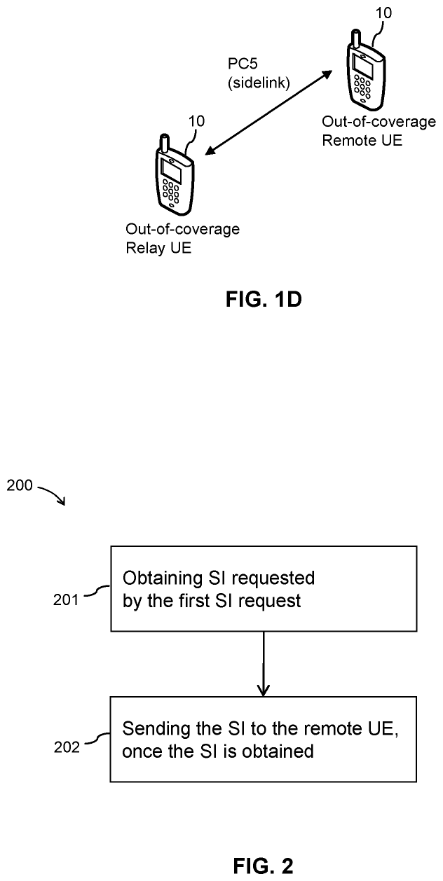

FIG. 1A illustrates an exemplary sidelink communication scenario. In particular, FIG. 1A shows multiple UEs 10, which are connected to each other by radio links implementing direct wireless links (illustrated by double-headed arrows). Further, one of the UEs 10 is connected by a radio link to a base station node 100 of a wireless communication network, e.g., to an eNB of the LTE technology, or a gNB of the NR technology. The base station 100 is part of a RAN (Radio Access Network) of the wireless communication network, which typically also includes further base stations to provide a desired coverage of the wireless communication network. Further, FIG. 1A shows a core network (CN) 210 of the wireless communication network. The CN 210 may provide connectivity of the UEs 10 to other data networks, e.g., through a GW 220 provided in the CN 210. Further, the CN 210 may also include various nodes for controlling operation of the UEs 10. The radio link between UE 10 and base station may be based on the Uu interface of the LTE technology or the Uu interface of the NR technology. The radio links between the UEs 10 may be based on the PC5 interface of the LTE technology or the PC5 interface of the NR technology.

The radio links may be used for sidelink communication between the UEs 10. Further, the radio link to the wireless communication network may be used for controlling or otherwise assisting the sidelink communication. Further, the sidelink communication and/or data communication with the wireless communication network may be used for providing various kinds of services to the UEs 10, e.g., a voice service, a multimedia service, a data service, an intelligent transportation system (ITS) or similar vehicular management or coordination service, an NSPS (National Security and Public Safety) service, and/or an NCIS (Network Controlled Interactive Service). Such services may be based on applications which are executed on the UE 10 and/or on a device linked to the UE 10. Accordingly, in the illustrated concepts a sidelink transmission may convey or correspond to a V2X message, an ITS message, or some other kind of message related to a service. Further, FIG. 1A illustrates an application service platform 250 in the CN 210 of the wireless communication network. Further, FIG. 1A illustrates one or more application servers 300 provided outside the wireless communication network. The application(s) executed on the UE 10 and/or on one or more other devices linked to the UE 10 may use the radio links with one or more other UEs 10, the application service platform 250, and/or the application server(s) 300, thereby enabling the corresponding service(s) on the UE 10. In some scenarios, the services utilized by the UEs 10 may thus be hosted on the network side, e.g., on the application service platform 250 or on the application server(s) 300. However, some of the services may also network-independent so that they can be utilized without requiring an active data connection to the wireless communication network. This may for example apply to certain V2X services or NSPS (National Security and Public Safety) services. Such services may be used in out-of-coverage situations, but could still be assisted from the network side while the UE 10 is in coverage of the wireless communication network, e.g., by configuring the UEs 10 with respect to the usage of the services. The application service platform 250 and the server(s) 300 may also be regarded as host computer which hosts a service provided by an application executed on the UE 10 and utilizes downlink transmissions, uplink transmissions, and/or sidelink transmissions.

In the example of FIG. 1A, the UEs 10 are assumed to be a mobile phone and vehicles or vehicle-based communication devices, e.g., a vehicle-mounted or vehicle-integrated communication module, or a smartphone or other user device linked to vehicle systems. However, it is noted that other types of UE could be used as well, e.g., a device carried by a pedestrian, or an infrastructure-based device, such as a roadside unit.

In the scenario of FIG. 1A, one of the UEs 10 could as a relay UE for another one of the UEs 10, denoted as remote UE. In such scenarios, concepts of the present disclosure may be used for providing SI to the remote UE.

FIG. 1B illustrates an in-coverage scenario in which the concepts of the present disclosure may be applied. FIG. 1C illustrates a partial coverage scenario in which the concepts of the present disclosure may be applied. FIG. 1D illustrates an out-of coverage scenario in which the concepts of the present disclosure may be applied. In the in-coverage scenario of FIG. 1B two UEs 10 are connected via sidelink an in coverage of a base station 100, e.g., an eNB or a gNB, and one of the UEs 10 acts as relay UE for the other UE 10, which thus corresponds to a remote UE of the concepts of the present disclosure. In the partial coverage scenario of FIG. 1C, only the relay UE is in coverage of the base station 100. In the out-of coverage scenario of FIG. 1D, two UEs 10 are out-of coverage. The scenario of FIG. 1D may for example occur when, starting from the partial coverage scenario of FIG. 1C, also the relay UE moved out of coverage of the base station 100.

A flowchart of a method 200 for a relay UE to handle a first SI request received from a remote UE, while a prohibit timer in the relay UE for requesting SI from a base station is running according to the present disclosure is shown in FIG. 2, and comprises the following steps: step 201 of obtaining SI requested by the first SI request; and step 202 of sending the SI to the remote UE, once the SI is obtained.

According to an embodiment of the method 200, the prohibit timer is the only prohibit timer in the relay UE. Alternatively, the prohibit timer can be one of multiple prohibit timers in the relay defined for the relay UE itself and one or more remote UEs including the remote UE.

According to an embodiment of the method 200, obtaining the SI refers to retrieving the SI from a memory of the relay UE, if the SI is stored in the memory.

According to an embodiment of the method 200, obtaining the SI refers to waiting for and receiving the SI from a base station, if an SI request causing current running of the prohibit timer already requested the SI from the base station.

According to an embodiment of the method 200, obtaining the SI refers to forwarding the first SI request or sending a second SI request for requesting the SI to a base station once the prohibit timer expires, and receiving the SI from the base station.

According to an embodiment of the method 200, obtaining the SI refers to sending a second SI request for requesting the SI and other SI to a base station once the prohibit timer expires, and receiving the SI and the other SI from the base station.

According to an embodiment of the method 200, the other SI is requested by the relay UE and/or by one or more other remote UEs within a time window, before the prohibit timer expires. The time window may be configured by a base station semi-statically or dynamically.

According to an embodiment of the method 200, obtaining the SI refers to forwarding the first SI request or sending a second SI request for requesting the SI, immediately after receiving the first SI request if the prohibit timer defined for the remote UE is not running, or once the prohibit timer defined for the remote UE expires if the prohibit timer defined for the remote UE is running.

According to an embodiment of the method 200, when the relay UE sends an SI request to a base station, the relay UE will inform one or more remote UEs that the SI request has been sent and/or what SI has been requested and/or the duration of the prohibit timer started due to the SI request which has been sent.

According to an embodiment of the method 200, a remote UE which is informed of the duration of the prohibit timer in the relay UE defined for the remote UE, will only send an SI request to the relay UE once that prohibit timer in the relay UE expires.

According to an embodiment of the method 200, the relay UE includes at least one of the following information in an SI request to a base station:
an indication on whether the request for SI is for one or more remote UEs;
an indication on whether the request for SI is for the relay UE;
an indication on whether the request for SI is for both the relay UE and one or more remote UEs;
what SI is requested by the relay UE;
what SI is requested by which remote UE;
what SI is requested by both the relay UE and one or more remote UEs;
one or more IDs of one or more remote UEs;
which remote UE(s) is/are in RRC_IDLE/RRC_INACTIVE.

According to an embodiment of the method 200, the remote UE includes an indication in the first SI request that the request and corresponding requested SI are for the remote UE.

According to an embodiment of the method 200, at least one of the following prohibit timers are defined in the remote UE:
a first prohibit timer defined for the remote UE to request SI via the relay UE from a base station;
a second prohibit timer defined for the remote UE to request SI from the relay UE.

According to an embodiment of the method 200, the first prohibit timer and/or the second prohibit timer is configured by the relay UE.

According to an embodiment of the method 200, the signaling between the relay UE and a base station uses one or more of the following:
RRC signaling;
MAC (Medium Access Control) CE (Control Element);
Control PDU (Packet Data Unit) of a protocol layer;
Layer 1 (L1) signaling.

According to an embodiment of the method 200, the signaling between the relay UE and a remote UE uses one or more of the following:
RRC signaling;
PC5-S signaling;
Discovery signaling;
MAC CE;
Control PDU of a protocol layer;
L1 signaling.

In the method 200, the relay UE and the remote UE may correspond to any of the above-mentioned UEs 10, and the base station may correspond to the above-mentioned base station 100.

Both the relay UE and the remote UE can be implemented as a network element on a dedicated hardware, as a firmware or a software instance running on a hardware, as a virtualized function instantiated on an appropriate platform (e.g. on a cloud infrastructure), or as any combination thereof.

Now, the embodiments will be described in connection with the cellular communication system. It can be understood that, although the further embodiments herein are described in the context of the cellular communication system, the embodiments can be also applied to other different communication systems, if the same problem exists in their mechanisms for requesting information via a relay link. It will be also understood that, although specific terms are used in the embodiments, the embodiments are not limited to those specific terms but may be applied to all similar entities. For example, the term “base station”/“BS” herein may refer to e.g. access point, base station, macro base station, femto base stations, NodeB (NB), eNodeB (eNB), gNodeB (gNB) and so on, and the “User Equipment”/“UE” herein may refer to e.g. user terminal, station, terminal, terminal node, and so on.

According to the present disclosure, the relay UE may have only one prohibit timer or multiple prohibit timers.

Regardless of whether the relay UE has only one prohibit timer or multiple prohibit timers, if the relay UE receives a first SI request received from a remote UE, while a prohibit timer in the relay UE for requesting SI from a base station is running, the relay UE may determine whether the SI requested by the first SI request is stored in the memory or not. The SI may be already stored in a memory of the relay UE, because the relay UE requested the SI before. If the SI indeed is stored in a memory of the relay UE, the relay UE obtains the SI by directly retrieving the SI from the memory, without needing to send the first SI request to a base station.

If the SI is not stored in a memory of the relay UE, the relay UE may determine whether an SI request which caused current running of the prohibit timer already requested the SI from the base station. If the SI request which caused current running of the prohibit timer already requested the SI from the base station, the relay UE may just wait for and receive the SI from a base station, without needing to send the first SI request to a base station.

Further embodiments will be described with respect to the two arrangements of prohibit timer in the relay UE respectively.

### I. The Relay UE Has Only One Prohibit Timer

In this arrangement where the prohibit timer is the only prohibit timer in the relay UE, if the SI is not stored in a memory of the relay UE, and the SI request which caused current running of the prohibit timer didn't request the SI from the base station, the relay UE may obtain the SI requested by the first SI request, by forwarding the first SI request (e.g., when the Remote UE is in RRC_CONNECTED status) or sending a second SI request for requesting the SI to a base station (e.g., when the Remote UE is in RRC_IDLE or RRC_INACTIVE status), once the prohibit timer expires, and then receiving the SI from the base station. Of course, the first SI request will be stored in a memory of the relay UE before forwarding the first SI request or sending the second SI request.

In an embodiment, the relay UE may obtain the SI requested by the first SI request, by sending a second SI request for requesting not only the SI but also other SI, if necessary, to a base station once the prohibit timer expires, and receiving the SI and the other SI from the base station.

In a further embodiment, the other SI is requested by the relay UE and/or by one or more other remote UEs within a time window, before the prohibit timer expires.

When the time window is set up, on or more remote UEs may send their first SI requests to the relay UE. Based on these first SI requests, the relay UE may choose to send a single second SI request to the base station. This time window can be periodic/aperiodic, and can be preconfigured in the specification and/or semi-statically/dynamically configured by the base station at the relay UE, then the relay UE may forward configuration of the time window to one or more remote UEs. In addition, for the relay UE in RRC_IDLE/INACTIVE state, the window can be synchronized with the DRX (Discontinuous Reception) On times.

### II. The Relay UE Has Multiple Prohibit Timers

In this arrangement, the prohibit timer is one of multiple prohibit timers in the relay UE defined for the relay UE itself and one or more remote UEs, including the remote UE from which the first SI request is received.

In an embodiment, in addition to one prohibit timer defined for the relay UE for itself, there may be one or more additional prohibit timers defined for one or more remote UEs, wherein each of the one or more additional prohibit timers is defined for a specific remote UE or a specific type/category of remote UEs. For different remote UEs carrying/employing different services/traffic types, prohibit timers may be configured differently in the relay UE. For example, for remote UEs requiring fast on-demand SIB delivery (e.g., remote UEs may be associated with specific categories or specific traffic types), the value of the prohibit timer may be shorter compared to that of the prohibit timer of other remote UEs not requiring fast on-demand SIB delivery. In this way, the QoS (Quality of Service) requirements of different services/traffic types are considered when defining the prohibit timers in the relay UE.

For such a relay UE having multiple prohibit timers according to the present disclosure, If the relay UE receives a first SI request received from a remote UE, while a prohibit timer in the relay UE for requesting SI from a base station is running, the relay UE may obtain the SI requested by the first SI request, by forwarding the first SI request (e.g., when the Remote UE is in RRC_CONNECTED status) or sending a second SI request for requesting the SI (e.g., when the Remote UE is in RRC_IDLE or RRC_INACTIVE status), immediately after receiving the first SI request if the prohibit timer defined for the remote UE is not currently running. In the other hand, if the prohibit timer defined for the remote UE is currently running, the relay UE may obtain the SI requested by the first SI request, by forwarding the first SI request or sending a second SI request for requesting the SI once the prohibit timer defined for the remote UE expires.

As an example embodiment, If the relay UE is defined with an additional prohibit timer for a remote UE denoted prohibit_timer_for_remote, the relay UE starts such a timer for the remote UE only when the relay UE has sent an SI request for on-demand SIB for the remote UE regardless whether the relay UE has started the prohibit timer for itself denoted prohibit_timer_for_relay (i.e., no matter the prohibit timer has been started after the relay UE has send an SI request to a base station for requesting on-demand SI for itself). The relay UE should not request on-demand for SI itself/remote UE as long as prohibit_timer_for_relay/prohibit_timer_for_remote is running, while the relay UE could request on-demand SI for itself/remote UE as long as is not running, even prohibit_timer_for_relay/prohibit_timer_for_remote prohibit_timer_for_remote/prohibit_timer_for_relay is running.

In another example embodiment, when the prohibit_timer_for_relay on the relay UE has expired, the relay UE may merge the request for its own SI (if it has to request some) and the SI requested by the remote UE in a unique request, in this case the relay UE is allowed to send the request if either prohibit_timer_for_relay or prohibit_timer_for_remote is not running, after sending the request, the relay UE should start the timer that is not running or also restart the timer that is running, which option to adopt could be configured by the network or preconfigured in the UE. In another embodiment, the relay UE can always prioritize the SI request of its own over that of a remote UE.

In a further example embodiment, two prohibit timers denoted prohibit_timer_for_relay_short and prohibit_timer_for_relay_normal may be defined for the relay UE to request on-demand SI for itself, while another two prohibit timers denoted prohibit_timer_for_remote_short and prohibit_timer_for_remote_normal may be defined for the relay UE to request on-demand SI for the remote UE. When the relay UE requests on-demand SI for itself, prohibit_timer_for_relay_normal and prohibit_timer_for_remote_short are started, while when the relay UE requests on-demand SI for remote UE, prohibit_timer_for_remote_normal and prohibit_timer_for_relay_short are started. Similar as described above, the relay UE should not request on-demand SI for itself/remote UE as long as prohibit_timer_for_relay_xxx/prohibit_timer_for_remote_xxx is running, where “xxx” may be “normal” and/or “short”. By this, when e.g. the relay UE requests on-demand SI for itself, it will be forbidden to request on-demand SIB for both itself and remote UE, while for remote UE the prohibit period will be short. This achieves a balance between power consumption and latency in acquiring SIB.

Next, more embodiments will be described, which may be seen as further embodiments for one or more of the above embodiments.

In an embodiment, when the relay UE sends an SI request to a base station, the relay UE will inform one or more remote UEs that the SI request has been sent and/or what SI has been requested and/or the duration of the prohibit timer started due to the SI request which has been sent. The relay UE may only inform this to the remote UE(s) in RRC_DILE/RRC_INACTIVE which may send an SI request to the relay UE rather than to a base station.

In a further embodiment, a remote UE, which is informed of the duration of the prohibit timer in the relay UE defined for the remote UE, will only send an SI request to the relay UE once that prohibit timer in the relay UE expires. Alternatively, the remote UE may also start its own prohibit timer (if the remote UE has one, as described below) based on the duration of the prohibit timer in the relay UE defined for the remote UE, and does not send an SI request to the relay UE and/or to the network via the relay UE as long as its own prohibit timer is still running.

In addition, the relay UE may include at least one of the following information in an SI request to a base station:
an indication on whether the request for SI is for one or more remote UEs;
an indication on whether the request for SI is for the relay UE;
an indication on whether the request for SI is for both the relay UE and one or more remote UEs;
what SI is requested by the relay UE;
what SI is requested by which remote UE;
what SI is requested by both the relay UE and one or more remote UEs;
one or more IDs of one or more remote UEs;
which remote UE(s) is/are in RRC_IDLE/RRC_INACTIVE.

When receiving an SI request including at least one of the above information, the base station may accordingly process the SI request, considering such information. Alternatively, the relay UE doesn't include any such information in the SI request. In this case, upon reception of the SI request, the base station will not need to identify such information, and will handle the SI request without considering such information, e.g. without considering whether the SI request is for a remote UE or not.

Also, the remote UE may include an indication in the first SI request that the request and corresponding requested SI are for the remote UE, e.g., when the relay UE only forward the first SI request to a base station without amending the contents of the first SI request.

In another embodiment, a remote UE can also have one or more prohibit timers for system Information delivery in sidelink relay. For example, at least one of the following two prohibit timers may be defined in the remote UE regarding on-demand SI request: a first prohibit timer is defined for the remote UE to request on-demand SI via the relay UE from a base station; a second prohibit timer is defined for the remote UE to request on-demand SI from relay UE. The remote UE may be in any RRC state. The remote UE may be in cellular coverage or out of cellular coverage. For the second prohibit timer, upon sending an SI request to a base station via the relay UE, the remote UE starts the prohibit timer. For the second prohibit timer, upon sending an SI request to the relay UE, the remote UE starts the prohibit timer.

For different remote UEs carrying/employing different services/traffic types, prohibit timers may be configured differently in the remote UEs. For remote UEs requiring fast on-demand SIB delivery (e.g., remote UEs may be associated with specific categories or specific traffic types), the value of the prohibit timer may be shorter compared to the value of the prohibit timer in other remote UEs not requiring fast on-demand SIB delivery. In this way, the QoS requirements of different services/traffic types are considered when configuring the prohibit timers in the remote UEs.

The prohibit timers in the remote UE may be configured by the relay UE or by the network.

In the above embodiments, which option the UE should use may be decided by a base station and communicated to the UE via dedicated RRC signaling or via system information. As an alternative, which option the UE should use may be configured by a peer UE or pre-configured (hard-coded in the specification).

As for the signaling between the relay UE and a base station in the above embodiments, it may use one or more of the following:
RRC signaling;
MAC CE;
Control PDU of a protocol layer, e.g., SDAP (Service Data Adaptation Protocol), PDCP (Packet Data Convergence Protocol), RLC or an adaptation layer in case of sidelink relay;
L1 signaling on channels such as PRACH (Physical Random Access Channel), PUCCH (Physical Uplink Control Channel), PDCCH (Physical Downlink Control Channel), CCCH (Common Control Channel).

As for the signaling between the relay UE and a remote UE in the above amendments, it may use one or more of the following:
RRC signaling (e.g., PC5-RRC);
PC5-S signaling;
Discovery signaling;
MAC CE;
Control PDU of a protocol layer (e.g., SDAP, PDCP, RLC or an adaptation layer in case of sidelink relay);
L1 signaling on channels such as PSSCH (Physical Sidelink Shared Channel), PSCCH (Physical Sidelink Control Channel), or PSFCH (Physical Sidelink Feedback Channel).

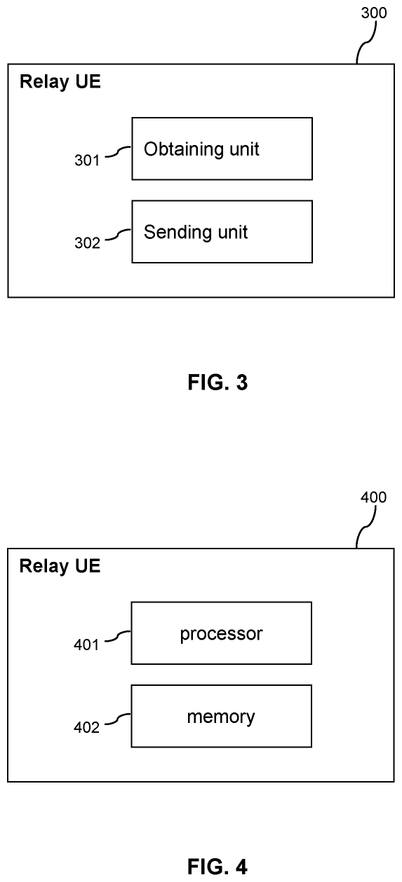

FIG. 3 is a schematic block diagram of a relay UE 300 to handle a first SI request received from a remote UE while a prohibit timer in the relay UE for requesting SI from a base station is running, the relay UE comprising: an obtaining unit 301 for obtaining SI requested by the first SI request; and a sending unit 302 for sending the SI to the remote UE, once the SI is obtained. The UE 300, specifically the obtaining unit 301 and the sending unit 302, may be configured to perform the above-mentioned method 200.

It can be appreciated that, the relay UE and the remote UE described herein may be implemented by various units, so that each of the relay UE and the remote UE implementing one or more functions described with the embodiments may comprise not only the units shown in the figure, but also other units for implementing one or more functions thereof. In addition, each of the relay UE and the remote UE may comprise a single unit configured to perform two or more functions, or separate units for each separate function. Moreover, the units may be implemented in hardware, firmware, software, or any combination thereof.

It is understood that blocks of the block diagrams and/or flowchart illustrations, and combinations of blocks in the block diagrams and/or flowchart illustrations, may be implemented by computer program instructions. These computer program instructions may be provided to a processor of a general purpose computer, special purpose computer, and/or other programmable data processing apparatus to produce a machine, such that the instructions, which execute via the processor of the computer and/or other programmable data processing apparatus, create means for implementing the functions/acts specified in the block diagrams and/or flowchart block or blocks.

Furthermore, the solution of the present disclosure may take the form of a computer program on a memory having computer-usable or computer-readable program code embodied in the medium for use by or in connection with an instruction execution system. In the context of this document, a memory may be any medium that may contain, store, or is adapted to communicate the program for use by or in connection with the instruction execution system, apparatus, or device.

Therefore, the present disclosure also provides a relay UE 400 including a processor 401 and a memory 402, as shown in FIG. 4. In the relay UE 400, the memory 402 stores instructions that when executed by the processor 401 cause the relay UE 400 to perform the method for the relay UE described above with the embodiments, e.g., the above-mentioned method 200.

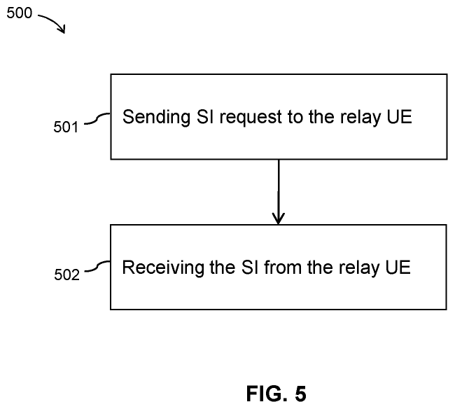

A flowchart of a method 500 for a remote UE to handle an SI request to a relay UE according to the present disclosure is shown in FIG. 5. The method 500 comprises a step 501 of sending an SI request to the relay UE. The SI request has the purpose of requesting SI from the relay UE or for requesting SI via the relay UE from a base station The remote UE sends the SI request based on one or more prohibit timers defined in the remote UE. Further, the method may comprise a step 502 of receiving the requested SI from the relay UE.

According to an embodiment of the method 500, the remote UE does not send the SI request to the relay UE while at least one of the one or more prohibit timers in the remote UE is running.

According to an embodiment of the method 500, at least one of the one or more prohibit timers in the remote UE may be based on information on duration of a prohibit timer in the relay UE.

According to an embodiment of the method 500, the remote UE receives information from the relay UE that the relay UE sent an SI request to the base station and/or what SI has been requested and/or the duration of the prohibit timer started due to the SI request which has been sent.

According to an embodiment of the method 500, the remote UE includes an indication in the first SI request that the request and corresponding requested SI are for the remote UE.

According to an embodiment of the method 500, the one or more of the prohibit timers in the remote UE comprise at least one of the following:
a first prohibit timer defined for the remote UE to request SI via the relay UE from a base station;
a second prohibit timer defined for the remote UE to request SI from the relay UE.

The first prohibit timer and/or the second prohibit timer may be configured by the relay UE.

According to an embodiment of the method 500, at least one of the one or more of the prohibit timers in the remote UE depend on service type or traffic type.

According to an embodiment of the method 500, the remote UE sends the SI request within a configured time window.

According to an embodiment of the method 500, the signaling between the remote UE and the relay UE uses one or more of the following:
RRC signaling;
PC5-S signaling;
Discovery signaling;
MAC CE;
Control PDU of a protocol layer;
L1 signaling.

In the method 500, the relay UE and the remote UE may correspond to any of the above-mentioned UEs 10, and the base station may correspond to the above-mentioned base station 100.

Both the relay UE and the remote UE can be implemented as a network element on a dedicated hardware, as a firmware or a software instance running on a hardware, as a virtualized function instantiated on an appropriate platform (e.g. on a cloud infrastructure), or as any combination thereof.

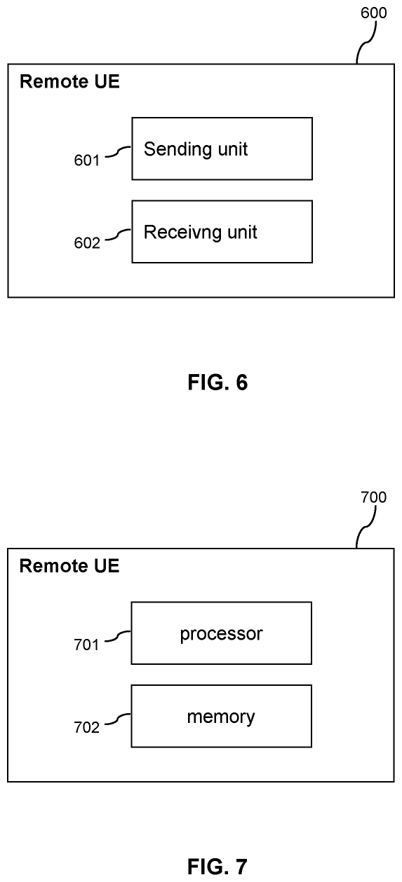

FIG. 6 is a schematic block diagram of a remote UE 600 to handle an SI request to a relay UE. The remote UE 600 comprises a sending unit 601 for sending, based on one or more prohibit timers defined in the remote UE, an SI request to a relay UE. The SI request has the purpose of requesting SI from the relay UE or for requesting SI via the relay UE from a base station

[symbol]

The remote UE 600, specifically the sending unit 601 and the receiving unit 602, may be configured to perform the above-mentioned method 500.

Therefore, the present disclosure also provides a remote UE 700 including a processor 701 and a memory 702, as shown in FIG. 7. In the remote UE 700, the memory 702 stores instructions that when executed by the processor 701 cause the remote UE 700 to perform the method for the relay UE described above with the embodiments, e.g., the above-mentioned method 500.

While this specification contains many specific implementation details, these should not be construed as limitations on the scope of any implementation or of what may be claimed, but rather as descriptions of features that may be specific to particular embodiments of particular implementations. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

It will be obvious to a person skilled in the art that, as the technology advances, the inventive concept can be implemented in various ways. The above described embodiments are given for describing rather than limiting the disclosure, and it is to be understood that modifications and variations may be resorted to without departing from the spirit and scope of the disclosure as those skilled in the art readily understand. Such modifications and variations are considered to be within the scope of the disclosure and the appended claims. The protection scope of the disclosure is defined by the accompanying claims.

1-36. (canceled)

37. A method for a relay User Equipment (relay UE) to handle a first System Information (SI) request received from a remote User Equipment (remote UE) while a prohibit timer in the relay UE for requesting SI from a base station is running, the method comprising:
obtaining SI requested by the first SI request;
sending the SI to the remote UE, once the SI is obtained.

38. The method of claim 37, wherein the prohibit timer is one of multiple prohibit timers in the relay UE defined for the relay UE itself and one or more remote UEs including the remote UE.

39. The method of claim 37, wherein obtaining the SI refers to waiting for and receiving the SI from a base station, if an SI request causing current running of the prohibit timer already requested the SI from the base station.

40. The method of claim 38, wherein the prohibit timer is the only prohibit timer in the relay UE and wherein obtaining the SI refers to forwarding the first SI request or sending a second SI request for requesting the SI to a base station once the prohibit timer expires, and receiving the SI from the base station.

41. The method of claim 38, wherein the prohibit timer is the only prohibit timer in the relay UE and wherein obtaining the SI refers to sending a second SI request for requesting the SI and other SI to a base station once the prohibit timer expires, and receiving the SI and the other SI from the base station.

42. The method of claim 38, wherein obtaining the SI refers to forwarding the first SI request or sending a second SI request for requesting the SI, immediately after receiving the first SI request if the prohibit timer defined for the remote UE is not running, or once the prohibit timer defined for the remote UE expires if the prohibit timer defined for the remote UE is running.

43. The method of claim 37, wherein when the relay UE sends an SI request to a base station, the relay UE will inform one or more remote UEs that the SI request has been sent and/or what SI has been requested and/or the duration of the prohibit timer started due to the SI request which has been sent.

44. The method of claim 37, wherein the relay UE includes at least one of the following information elements in an SI request to a base station:
an indication on whether the request for SI is for one or more remote UEs;
an indication on whether the request for SI is for the relay UE;
an indication on whether the request for SI is for both the relay UE and one or more remote UEs;
what SI is requested by the relay UE;
what SI is requested by which remote UE;
what SI is requested by both the relay UE and one or more remote UEs;
one or more IDs of one or more remote UEs;
which remote UE(s) is/are in RRC_IDLE/RRC_INACTIVE.

45. The method of claim 37, wherein the remote UE includes an indication in the first SI request that the request and corresponding requested SI are for the remote UE.

46. A relay User Equipment (relay UE) to handle a first System Information (SI) request received from a remote User Equipment (remote UE) while a prohibit timer in the relay UE for requesting SI from a base station is running, the relay UE comprising:
a processor; and
a memory, having stored instructions that when executed by the processor cause the relay UE to perform the method of claim 37.

47. A method for a remote User Equipment (remote UE), the method comprising:
based on one or more prohibit timers defined in the remote UE, sending a System Information (SI) request to a relay User Equipment (relay UE) for requesting SI from the relay UE or for requesting SI via the relay UE from a base station.

48. The method of claim 47, wherein the remote UE does not send the SI request to the relay UE while at least one of the one or more prohibit timers in the remote UE is running.

49. The method of claim 47, wherein at least one of the one or more prohibit timers in the remote UE is based on information on duration of a prohibit timer in the relay UE.

50. The method of claim 47, wherein the remote UE receives information from the relay UE that the relay UE sent an SI request to the base station and/or what SI has been requested and/or the duration of the prohibit timer started due to the SI request which has been sent.

51. The method of claim 47, wherein the remote UE includes an indication in the first SI request that the request and corresponding requested SI are for the remote UE.

52. The method of claim 47, wherein the one or more of the prohibit timers in the remote UE comprise at least one of the following:
a first prohibit timer defined for the remote UE to request SI via the relay UE from a base station;
a second prohibit timer defined for the remote UE to request SI from the relay UE.

53. The method of claim 52, wherein the first prohibit timer and/or the second prohibit timer is configured by the relay UE.

54. The method of claim 47, wherein at least one of the one or more of the prohibit timers in the remote UE depend on service type or traffic type.

55. The method of claim 47, wherein the remote UE sends the SI request within a configured time window.

56. A remote User Equipment (remote UE) the remote UE comprising:
a processor; and
a memory, having stored instructions that when executed by the processor cause the remote UE to perform the method of claim 47.
